(19) United States
(12) Patent Application Publication
(10) Pub. No.: US 2023/0373075 A1
(43) Pub. Date: Nov. 23, 2023

(54) GAITER WITH COUPLING

(71) Applicant: Snap-on Incorporated, Kenosha, WI (US)

(72) Inventor: Jonathan I. Andersen, Kenosha, WI (US)

(73) Assignee: Snap-on Incorporated, Kenosha, WI (US)

(21) Appl. No.: 17/748,801

(22) Filed: May 19, 2022

(51) Int. Cl. B25G 1/12; B25B 23/00

(52) U.S. Cl. CPC B25G 1/125; B25B 23/0042

(57) ABSTRACT

An insulated tool gaiter with a non-conducting quick connect/disconnect coupling that can be coupled to a handle of a composite handled insulating tool. This allows a quick disconnect and reconnect to a number of different tools fitted with a corresponding coupling. The gaiter can be used in combination with insulating style tools to protect the technician. The insulated gaiter can be coupled to the tool at one end, and encapsulate or envelope the technician's hand, and is removably fixed at the other end with a cuff around the technician's forearm. The gaiter insulates the technician from arcing dangers while allowing the technician's hand to interface directly with the handle of the tool, allowing better control and grip that can otherwise be compromised when a technician is wearing thick, cumbersome insulating gloves.

### TECHNICAL FIELD

The present application relates generally to insulated tool gaiters, and more particularly to insulated tool gaiters with a quick connect/disconnect coupling.

### BACKGROUND

When performing maintenance or other work on or around live electrical circuits, a technicians must be weary to prevent shock or electrical arcing to avoid accidental injury. It is common for the technician to insulate himself/herself from electrical conductors to prevent shock or electrical arcing by using insulating or non-conductive tools. By design, insulating or non-conductive tools have no metal or conducting materials that would be disposed in the technician's hand. However, an outer portions of the technician's hand may still be exposed to shock or arcing.

To protect the technician's hand, the technician generally wears gloves, such as gloves with a leather exterior, rubber liner, and cotton interior. However, these types of gloves are generally thick and stiff, which can impair or cause it to be difficult for the technician to manipulate a tool while wearing such gloves.

### SUMMARY

The present invention relates broadly to an insulated tool gaiter with a non-conducting quick connect/disconnect coupling that can be coupled to a handle of a composite handled insulating tool. This allows a quick disconnect and reconnect to a number of different tools fitted with a corresponding coupling. When working on live electrical circuits, it is required to insulate the technician to prevent shock or electrical arcing. The gaiter can be used in combination with insulating style tools to protect the technician. By design, insulating tools have no metal or conducting materials contacting the technician's hand. However, this leaves the outer portions of the technician's hand exposed to shock or arcing.

To protect the technician's hand, the insulated gaiter can be coupled to the tool at one end, and encapsulates or envelopes the technician's hand, and is removably fixed at the other end with a cuff around the technician's forearm. The gaiter insulates the technician from arcing dangers while allowing the technician's hand to interface directly with the handle of the tool, allowing better control and grip that can otherwise be compromised when a technician is wearing thick, cumbersome insulating gloves.

In an embodiment, Aa gaiter for use with a tool is described. The gaiter includes a main body having opposing first and second ends, and is adapted to surround a hand of a user. A first gaiter coupling is coupled to the first end, and a tool coupling is adapted to couple to the tool and removably mate with the first gaiter coupling to removably couple the tool to the main body.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an insulated gaiter with couplings, according to an embodiment of the present invention.

FIG. 2 is an exploded view of the insulated gaiter with couplings of FIG. 1.

FIG. 3 is a section side view of the insulated gaiter with couplings of FIG. 1.

FIG. 4 is a section side view of a composition of the material of the gaiter.

FIG. 5 is a perspective view of a tool with a coupling disposed thereon, according to an embodiment of the present invention.

### DETAILED DESCRIPTION

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to an insulated gaiter with a non-conducting quick connect/disconnect coupling that can be coupled to a handle of a composite handled insulating tool. This allows a quick disconnect and reconnect to a number of different tools fitted with a corresponding coupling. When working on live electrical circuits, it is required to insulate the technician to prevent shock or electrical arcing. The gaiter can be used in combination with insulating style tools to protect the technician. By design, insulating tools have no metal or conducting materials contacting the technician's hand. However, this leaves the outer portions of the technician's hand exposed to shock or arcing.

To protect the technician's hand, the insulated gaiter can be coupled to the tool at one end, and encapsulates or envelopes the technician's hand, and is removably fixed at the other end with a cuff around the technician's forearm. The gaiter insulates the technician from arcing dangers while allowing the technician's hand to interface directly with the handle of the tool, allowing better control and grip that can otherwise be compromised when a technician is wearing thick, cumbersome insulating gloves.

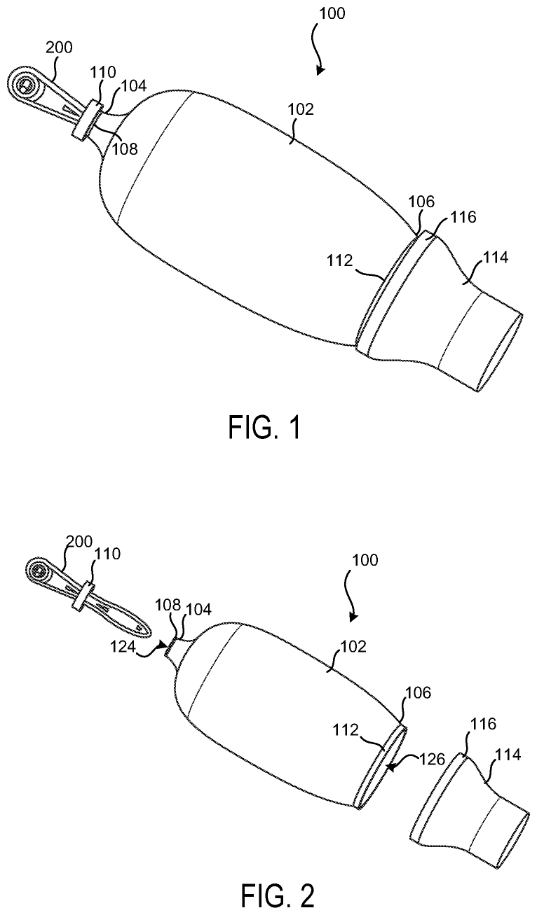

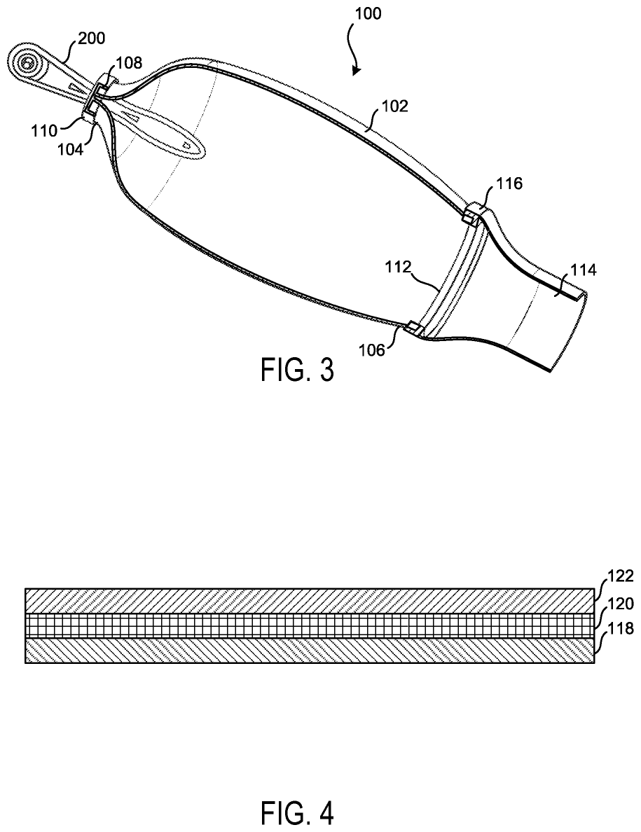

Referring to FIGS. 1-3, an insulated gaiter 100 includes a main body 102 having opposing first and second ends 104, 106, a first gaiter coupling 108 coupled to the first end 104, and a tool coupling 110 adapted to couple to a tool (such as tool 200, for example) and mate with the first gaiter coupling 108 to couple the tool 200 to the insulated gaiter 100. The insulated gaiter 100 may also include a second gaiter coupling 112 coupled to the second end 106, and an arm cuff portion 114 with a corresponding cuff coupling 116 adapted to mate with the second gaiter coupling 112 to couple the arm cuff portion 114 to the insulated gaiter 100.

The main body 102 is made of an insulating material adapted to protect and insulate a user or technician to prevent shock or electrical arcing. In an example, referring to FIG. 4, the main body 102 can include multiple layers, such as a first layer 118, second layer 120, and third layer 122. The first layer 120 may form an inner or internal side of the main body 102 that contacts the users hand and/or arm. The first layer 120 may be made of a material that provides comfort and/or moisture wicking ability. For example, the first layer may be cotton, wool, fleece, polyester, etc. The second layer 120 may form an insulating barrier, and may be any non-conducting material, such as rubber and other materials that prevent electrical shock or arcing. The third layer 122 may form an exterior side of the main body 102. The third layer 122 may be made of a material that is non-conducting and provides durability and/or abrasion resistance. For example, the third layer may be leather, Kevlar, or other non-conducting abrasion resistant material.

Referring to FIGS. 1-3, the main body 102 may be adapted to surround a hand and/or wrist/arm of the user. In this respect, the main body 102 may have a middle diameter or size that can receive and surround a hand and/or wrist/arm of the user. The middle diameter or size may taper to the first end 104 to a reduced first diameter or size (i.e., smaller than the middle diameter or size). Optionally, the middle diameter or size may taper to the second end 106 to a reduced second diameter or size (i.e., smaller than the middle diameter or size). The first diameter or size may also be smaller than the second diameter or size.

The main body 102 may also include a first opening 124 proximal to the first end 104, and the first gaiter coupling may include a corresponding opening, that is adapted to receive the insertion of a handle of a tool (such as the tool 200), and a second opening 126 proximal to the second end 106 that is adapted to allow the insertion of the user's hand into the main body 102 of the gaiter 100. The first opening 124 allows the user to grasp the handle of the tool, while the user's hand remains inside the main body 102 of the gaiter 100. In other words, the gaiter 100 insulates the user from arcing dangers while allowing the user's hand to interface directly with the handle of the tool, allowing better control and grip that can otherwise be compromised when wearing thick, cumbersome insulating gloves, instead.

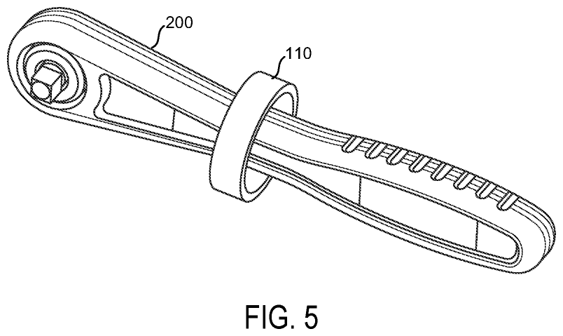

Referring to FIGS. 1-3 and 5, the first gaiter coupling 108 and tool coupling 110 may form a first coupling mechanism, where the first gaiter coupling 108 and tool coupling 110 mate with each other in a quick connect/disconnect manner. The first gaiter coupling 108 and tool coupling 110 may also be made of any non-conducting material suitable for couplings, such as plastics, and other polymers.

The first coupling mechanism formed by the first gaiter coupling 108 and tool coupling 110 may be any kind of quick connect/disconnect coupling. For example, a friction fit type of mating coupling, a twist lock type of mating coupling, a snap-fit type of mating coupling or other type of quick connect/disconnect coupling known in the art.

The first gaiter coupling 108 may be rigidly coupled to the first end 104 of the main body 102 and/or could be removable to allow for replacement. Similarly, the tool coupling 110 may be rigidly coupled to the tool (such as the tool 200) and/or could be removable to allow for removal and placement on one or more different tools. In an example, the tool coupling 110 may have an opening formed by a flexible insulating material that allows the tool coupling 110 to be slid onto a handle of the tool and friction fit onto the tool. The tool may also be any type of insulating tool that has no metal or conducting materials contacting the user's hand.

Referring again to FIGS. 1-3, the main body 102 may optionally include the second gaiter coupling 112 coupled to the second end 106, and the arm cuff portion 114 with a corresponding cuff coupling 116 adapted to mate with the second gaiter coupling 112 to couple the arm cuff portion 114 to the insulated gaiter 100. The second gaiter coupling 112 and cuff coupling 116 may form a second coupling mechanism, where the second gaiter coupling 112 and cuff coupling 116 mate with each other in a quick connect/disconnect manner. The second gaiter coupling 112 and cuff coupling 116 may also be made of any non-conducting material suitable for couplings, such as plastics, and other polymers.

The second coupling mechanism formed by the second gaiter coupling 112 and cuff coupling 116 may be any kind of quick connect/disconnect coupling. For example, a friction fit type of mating coupling, a twist lock type of mating coupling, a snap-fit type of mating coupling or other type of quick connect/disconnect coupling known in the art.

In this example, the second gaiter coupling 112 may be rigidly coupled to the second end 106 of the main body 102 and/or could be removable to allow for replacement. Similarly, the cuff coupling 116 may be rigidly coupled to the arm cuff portion 114 and/or could be removable to allow for replacement. In an example, the arm cuff portion 114 may be made of the same material as the main body 102 (such as described and shown in FIG. 4). In this example, the arm cuff portion 114 may have a reduced diameter an end opposite the cuff coupling 116 that is adapted to allow the insertion of the user's hand into the main body 102 of the gaiter 100. When the user's hand is inserted through the arm cuff portion 114 and into the main body 102, the arm cuff portion 114 may fit snuggly on the user's forearm. For quick removal of the gaiter 100, the main body 102 may be disconnected form the arm cuff portion 114 via the second coupling mechanism. In other embodiments, the arm cuff portion 114 and/or cuff coupling 116 may be integrated into other types of personal protective equipment (PPE) or clothing.

The tool coupling 110 can include numerous different couplings, where each one is connected to a different tool. This allows a quick disconnect and reconnect to a number of different tools fitted with the corresponding coupling. Thus, allowing the user to quickly and easily change between use of different tools without having to remove the gaiter 100.

The gaiter 100, replaces the need for the user to wear an insulated glove, which can be thick, heavy, and cumbersome; and reduce the user's dexterity and grip on the tool being used. This can be a problem when manipulating pick up tools, such as pliers, picks and other tools requiring fine movements and feedback feel during operation.

The coupling of the gaiter 100 to the tool (such as the tool 200) adds a stop to the tool handle reducing the risk of the user's hand from sliding closer to any steel or other component at the working end of the tool. The gaiter 100 can also provide complete coverage of the user's hand and up his/her forearm to prevent any contact electric shocks or damage to the user from arcing.

The replacement of the bulky glove material from between the user's hand and the tool handle provides multiple benefits including: better grip and sensitivity so the user can feel what the tool is doing, improved control of the tool, increased comfort since the hand is inside a protective gaiter instead of restrictive gloves. The quick connect/disconnect coupling at the tool allows one gaiter 100 to be used for multiple tools having the tool coupling 110. Further, the gaiter 100 can be quickly removed and reattached to the user if the user is wearing the arm cuff portion 114 on his/her forearm or the cuff coupling 116 is integrated to his/her PPE/clothing.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A gaiter for use with a tool, the gaiter comprising:
a main body having opposing first and second ends, and adapted to surround a hand of a user;
a first gaiter coupling coupled to the first end;
a tool coupling adapted to couple to the tool and removably mate with the first gaiter coupling to removably couple the tool to the main body.

2. The gaiter of claim 1, further comprising a second gaiter coupling coupled to the second end.

3. The gaiter of claim 2, further comprising cuff coupling adapted to removably mate with the second gaiter coupling.

4. The gaiter of claim 3, further comprising an arm cuff portion, wherein the cuff coupling is integrated into an arm cuff portion.

5. The gaiter of claim 3, wherein the cuff coupling is integrated into a piece of personal protective equipment (PPE) or clothing.

6. The gaiter of claim 1, further comprising a first opening proximal to the first end that is adapted to receive insertion of a handle of the tool.

7. The gaiter of claim 1, wherein the main body comprises an insulating material.

8. The gaiter of claim 1, wherein the main body includes first, second, and third material layers.

9. The gaiter of claim 8, wherein the first material layer forms an internal side of the main body, the third material layer forms an external side of the main body.

10. The gaiter of claim 8, wherein the second material layer is non-conductive.

11. The gaiter of claim 8, wherein the third material layer is non-conductive and abrasion resistant.

12. The gaiter of claim 1, wherein the main body has a middle size that tapers to a reduced first size at the first end.
